(19) United States
(12) Patent Application Publication
(10) Pub. No.: US 2026/0229438 A1
(43) Pub. Date: Aug. 6, 2026

(54) CIRCUIT PROTECTION UNIT AND CONDUCTIVE MODULE

(71) Applicant: YAZAKI CORPORATION, Tokyo (JP)

(72) Inventors: Katsunori Sato, Makinohara-shi (JP); Mariko Nakagawa, Makinohara-shi (JP); Yasuhiro Kominato, Makinohara-shi (JP); Miho Suzuki, Makinohara-shi (JP); Kota Morishige, Makinohara-shi (JP)

(21) Appl. No.: 19/530,370

(22) Filed: Feb. 5, 2026

(30) Foreign Application Priority Data
Feb. 6, 2025 (JP) 2025-018138

(51) Int. Cl. H01H 85/11; H01H 85/02; H01H 85/17; H01H 85/20; H01M 50/503; H01M 50/583

(52) U.S. Cl. CPC H01H 85/11; H01H 85/17; H01H 85/203; H01M 50/503; H01M 50/583; H01H 2085/025; H01H 2085/207

(57) ABSTRACT

A circuit protection unit includes: a conductive member that establishes conduction between a connection conductor that is a first electrical connection target and a battery monitoring unit that is a second electrical connection target, the conductive member including a fusible region that is fusion-cut when an overcurrent flows between the connection conductor and the battery monitoring unit and a non-fusible region that is adjacent to the fusible region, the fusible region and the non-fusible region being integrally formed by a same base material, the fusible region being plated with a plating material having a lower melting point than the base material, the non-fusible region being not plated with the plating material.

### CROSS-REFERENCE TO RELATED APPLICATION(S)

The present application claims priority to and incorporates by reference the entire contents of Japanese Patent Application No. 2025-018138 filed in Japan on Feb. 6, 2025.

### BACKGROUND OF THE INVENTION

### 1. Field of the Invention

The present invention relates to a circuit protection unit and a conductive module.

### 2. Description of the Related Art

As a technique related to a circuit protection unit and a conductive module in the related art, Japanese Patent No. JP 7 561 318 B1, for example, discloses a fuse unit as a circuit protection unit including a first terminal electrically connected to a mating member, a second terminal connected to a wiring member, a resin portion covering a part of the first terminal and a part of the second terminal, and a chip fuse. The chip fuse includes a first electrode mounted on a first connection portion and a second electrode mounted on a second connection portion, the first terminal or the second terminal has a notch recessed from an outer edge portion, and the notch defines the first connection portion or the second connection portion.

Although in such a circuit protection unit and a conductive module, for example, the separated first terminal and second terminal are electrically connected by the chip fuse, work related to production such as assembling of the circuit protection unit and fixing of the first terminal to the mating member may become complicated. Also, there is room for further improvement in the circuit protection unit in regard to a configuration for improving workability related to production.

### SUMMARY OF THE INVENTION

The present invention was made in view of the above circumstances, and an object thereof is to provide a circuit protection unit and a conductive module with improved workability related to production.

In order to achieve the above mentioned object, a circuit protection unit according to one aspect of the present invention includes a conductive member that establishes conduction between a first electrical connection target and a second electrical connection target, wherein the conductive member includes a fusible region that is fusion-cut when an overcurrent flows between the first electrical connection target and the second electrical connection target and a non-fusible region that is adjacent to the fusible region, the fusible region and the non-fusible region being integrally formed by a same base material, the fusible region is plated with a plating material having a lower melting point than the base material, and the non-fusible region is not plated with the plating material.

In order to achieve the above mentioned object, a circuit protection unit according to another aspect of the present invention includes a conductive member that establishes conduction between a first electrical connection target and a second electrical connection target, wherein the conductive member includes a fusible region that is fusion-cut when an overcurrent flows between the first electrical connection target and the second electrical connection target and a non-fusible region that is adjacent to the fusible region, the fusible region and the non-fusible region being integrally formed by a same base material, and the fusible region is covered with a cover that leads to relatively higher thermal insulation in the fusible region than thermal insulation in the non-fusible region.

In order to achieve the above mentioned object, a conductive module according to still another aspect of the present invention includes a connection conductor that is electrically connected to an electrode terminal of a battery cell constituting a battery module; and a circuit protection unit that electrically connects a battery monitoring unit that monitors a battery state of the battery cell to the connection conductor, wherein the circuit protection unit includes: a conductive member that establishes conduction between the connection conductor and the battery monitoring unit, the conductive member includes a fusible region that is fusion-cut when an overcurrent flows between the connection conductor and the battery monitoring unit and a non-fusible region that is adjacent to the fusible region, the fusible region and the non-fusible region being integrally formed by a same base material, the fusible region is plated with a plating material having a lower melting point than the base material, and the non-fusible region is not plated with the plating material.

In order to achieve the above mentioned object, a conductive module according to still another aspect of the present invention includes a connection conductor that is electrically connected to an electrode terminal of a battery cell constituting a battery module; and a circuit protection unit that electrically connects a battery monitoring unit that monitors a battery state of the battery cell to the connection conductor, wherein the circuit protection unit includes: a conductive member that establishes conduction between the connection conductor and the battery monitoring unit, the conductive member includes a fusible region that is fusion-cut when an overcurrent flows between the connection conductor and the battery monitoring unit and a non-fusible region that is adjacent to the fusible region, the fusible region and the non-fusible region being integrally formed by a same base material, and the fusible region is covered with a cover that leads to relatively higher thermal insulation in the fusible region than thermal insulation in the non-fusible region.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a circuit protection unit and a conductive module according to a first embodiment;

FIG. 2 is a perspective view illustrating a battery module, a connection conductor, and a battery monitoring unit according to the first embodiment;

FIG. 3 is a perspective view illustrating the circuit protection unit according to the first embodiment;

FIG. 4 is a perspective view illustrating a circuit protection unit according to a second embodiment;

FIG. 5 is a perspective view illustrating a circuit protection unit according to a third embodiment; and

FIG. 6 is a perspective view illustrating a circuit protection unit according to a fourth embodiment.

### DETAILED DESCRIPTION OF THE PREFERRED EMBODIMENTS

Hereinafter, embodiments according to the present invention will be described in detail on the basis of the drawings. Note that the present invention is not limited by the embodiments. In addition, constituent elements in the following embodiments include those that can be replaced and easily achieved by those skilled in the art or those that are substantially the same as such elements.

### First Embodiment

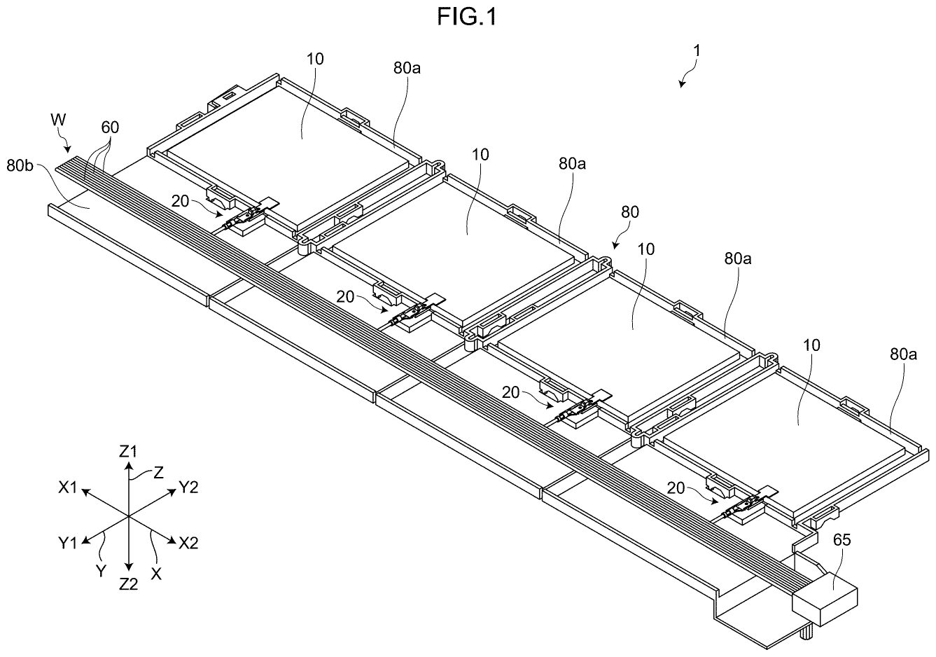

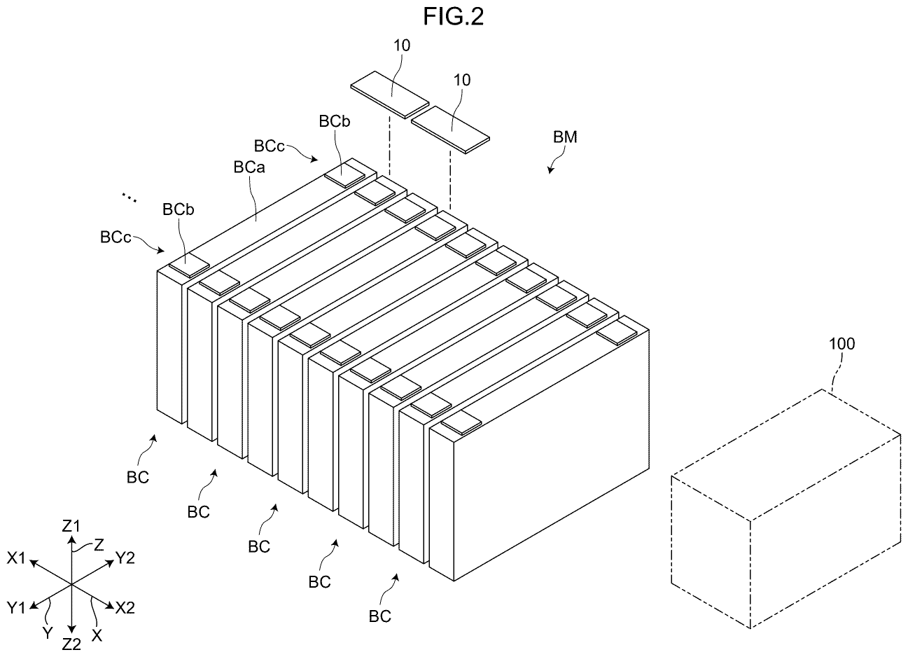

A first embodiment will be described with reference on the basis of FIGS. 1 to 3. A conductive module 1 illustrated in FIG. 1 is assembled with a battery module BM illustrated in FIG. 2. In the battery module BM, a plurality of battery cells BC are arranged. The battery module BM with which the conductive module 1 is assembled constitutes a battery pack. The battery pack is mounted on, for example, a vehicle (a battery electric vehicle (BEV), a hybrid electric vehicle (HEV), or the like) including a rotary machine as a drive source and is used for power supply to the rotary machine.

Note that in the following description, a direction in which the plurality of battery cells BC are arranged in an aligned manner will be referred to as a first direction X and two directions perpendicular to the first direction X will be referred to as a second direction Y and a third direction Z. The third direction Z is a direction orthogonal to upper surfaces of the battery cells BC, each of which is a surface where an electrode terminal BCb of the battery cell BC with a cell main body BCa formed in a substantially rectangular parallelepiped shape is provided. In the following description, one side in the first direction X will be referred to as one side X1, and the other side will be referred to as the other side X2. Similarly, one side and the other side in the second direction Y will be denoted by Y1 and Y2, respectively, and one side and the other side in the third direction Z will be denoted by Z1 and Z2, respectively.

As illustrated in FIG. 2, each battery cell BC is provided with the electrode terminal BCb on each of the one side Y1 and the other side Y2 in the second direction Y on the surface of the cell main body BCa of the battery cell BC on the one side Z1 in the third direction Z. One of the two electrode terminals BCb of each battery cell BC is a positive electrode, and the other one is a negative electrode. Each electrode terminal BCb of each battery cell BC provided on each of the one side Y1 and the other side Y2 in the second direction Y is aligned along the first direction X to constitute an electrode terminal group BCc. The electrode terminal group BCc is provided on each of the one side Y1 and the other side Y2 in the second direction Y in the battery module BM.

A connection conductor 10 is electrically connected to the electrode terminal BCb of each battery cell BC constituting the battery module BM. The connection conductor 10 can be fixed to the electrode terminal BCb by laser welding or the like. The connection conductor 10 connects, for example, two adjacent battery cells BC in series. In this case, the connection conductor 10 connects a positive electrode of one electrode terminal BCb and a negative electrode of another battery cell BC. The connection conductor 10 may be configured to connect two adjacent battery cells BC in parallel.

As illustrated in FIG. 1, the conductive module 1 includes a conductive module case 80, the connection conductor 10 (first electrical connection target), a circuit protection unit 20, and a routing material W. Note that the conductive module 1 including the connection conductor 10 fixed to each electrode terminal BCb can be provided for each electrode terminal group BCc (see FIG. 2). In this case, the conductive module 1 of one electrode terminal group BCc and the conductive module 1 of the other electrode terminal group BCc can be formed substantially symmetrically with respect to the second direction Y.

The conductive module case 80 is formed in a substantially flat plate shape. The conductive module case 80 has a plurality of conductor housing chambers 80a that accommodate the plurality of connection conductors 10, respectively. In the present embodiment, a bus bar formed in a flat plate shape by press molding or the like using a metal plate material can be used as the connection conductor 10. Each conductor housing chamber 80a is formed in a substantially long rectangular frame shape by standing walls surrounding the connection conductor 10. The plurality of conductor housing chambers 80a are arranged to be aligned along the first direction X.

A wiring path 80b through which the routing material W is routed is provided on one side Y1 of the second direction Y in the plurality of conductor housing chambers 80a in which the respective connection conductors 10 are housed. Here, the routing material W can be formed so as to extend in the first direction X by aligning a plurality of electric wires 60 one by one along the second direction Y. A connector 65 is provided at an end portion of the routing material W. The connector 65 is fitted to a mating connector (not illustrated), and both are electrically connected. The mating connector to which the connector 65 is fitted is provided in a battery monitoring unit 100 (second electrical connection target) illustrated in FIG. 2. The battery monitoring unit 100 monitors a battery state of each battery cell BC.

In the conductive module 1, one circuit protection unit 20 is provided for one connection conductor 10 so as to correspond to each connection conductor 10. The circuit protection unit 20 electrically connects the connection conductor 10 and the battery monitoring unit 100. The circuit protection unit 20 interrupts energization when an overcurrent flows between the connection conductor 10 and the battery monitoring unit 100.

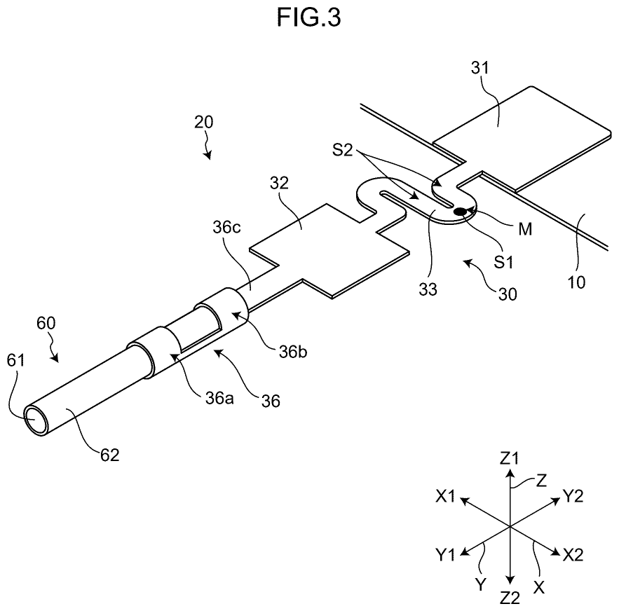

As illustrated in FIG. 3, the circuit protection unit 20 includes a conductive member 30 that establishes conduction between the connection conductor 10 and the battery monitoring unit 100. In the present embodiment, the conductive member 30 has an electric wire connection portion 36 to which the electric wire 60 is fixed, and is provided at a terminal of the electric wire 60. The conductive member 30 has a fusible region S1 that is fusion-cut when an overcurrent flows between the connection conductor 10 and the battery monitoring unit 100 and a non-fusible region S2 that is adjacent to the fusible region S1. The conductive member 30 includes a first conductive portion 31 on the connection conductor 10 side, a second conductive portion 32 on the battery monitoring unit 100 side, and a coupling portion 33 provided between the first conductive portion 31 and the second conductive portion 32.

Specifically, the conductive member 30 is integrally formed to include the first conductive portion 31, the second conductive portion 32, the coupling portion 33, and the electric wire connection portion 36 by performing press working such as punching and bending on one sheet metal material. The electric wire connection portion 36 includes a coating crimp portion 36a and a conductor crimp portion 36b. Here, the electric wire 60 includes a core wire 61 and an insulating coating portion 62 covering the core wire 61. In the present embodiment, the core wire 61 may be a stranded wire obtained by twisting a plurality of strands, or may be one single-core conductive wire.

The coating crimp portion 36a crimps and fixes the electric wire 60 to the conductive member 30 by caulking the outer periphery of the coating portion 62 of the electric wire 60 with a barrel piece or the like. The conductor crimp portion 36b crimps and fixes the core wire 61 to the conductive member 30 by caulking the core wire 61, which has been exposed by peeling the coating portion 62, with a barrel piece or the like. In this manner, conduction is established between the electric wire 60 (core wire 61) and the conductive member 30.

On the other hand, the first conductive portion 31 of the conductive member 30 is formed in a flat plate shape and is caused to serve as a conductor connection portion fixed to the connection conductor 10 by laser welding or the like. Conduction is established between the connection conductor 10 and the first conductive portion 31. The second conductive portion 32 of the conductive member 30 is formed in a flat plate shape. The second conductive portion 32 is connected to the electric wire connection portion 36 via a plate-like intermediate portion 36c on the one side Y1 in the second direction Y and is conductive therewith. The intermediate portion 36c is formed to be narrower than the second conductive portion 32. The coupling portion 33 is provided between the first conductive portion 31 and the second conductive portion 32. The coupling portion 33 has a plate shape and is formed to be curved so as to have an amplitude on the one side X1 and the other side X2 in the first direction X. In other words, the coupling portion 33 is formed in a substantially S shape. A part of the coupling portion 33 connecting the first conductive portion 31 and the second conductive portion 32 is formed linearly along the second direction Y. The coupling portion 33, including the linear part and the substantially S-shaped part, is formed to have a width narrower than the widths (the lengths in the first direction X) of the first conductive portion 31 and the second conductive portion 32. The width of the coupling portion 33 is formed to be substantially the same. The coupling portion 33 is formed to have a sectional area that is smaller than the sectional area of the first conductive portion 31 and is smaller than the sectional area of the second conductive portion 32.

The fusible region S1 and the non-fusible region S2 are provided in the coupling portion 33. As described above, the conductive member 30 is formed by press molding or the like of a metal plate, for example, one metal plate. In other words, the conductive member 30 is integrally formed of the same base material. In the conductive member 30, at least the fusible region S1 and the non-fusible region S2 are integrally formed of the same base material. The conductive member 30 is made of copper, a copper alloy, aluminum, or an aluminum alloy.

The fusible region S1 is plated with a plating material M having a lower melting point than that of a base material of the coupling portion 33 (for example, copper, a copper alloy, aluminum, or an aluminum alloy as a base material of the conductive member 30) where the fusible region S1 is provided. Specifically, the plating material M is tin plating containing tin. On the other hand, the non-fusible region S2 is not provided with the plating material M.

Once an overcurrent flows to the conductive member 30 of the circuit protection unit 20, the plating material M having a lower melting point than the core wire 61 as a base material is melted first. Then, the melted plating material M causes corrosion of the fusible region S1 and generates more heat than the non-fusible region S2. In the fusible region S1, corrosion of the base material further proceeds due to the heat generation, and the base material is then fusion-cut. Once the fusible region S1 is fusion-cut, energization between the connection conductor 10 and the battery monitoring unit 100 is disconnected, and the circuit and the like with which the battery monitoring unit 100 establishes conduction are protected.

### Second Embodiment

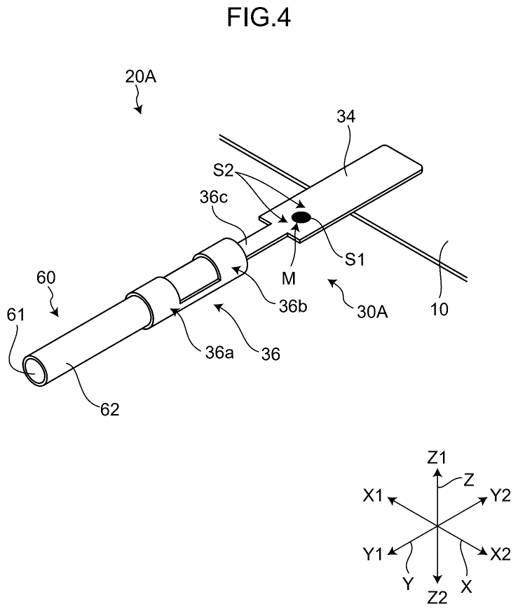

Next, a second embodiment will be described on the basis of FIG. 4. In regard to a circuit protection unit 20A of the present embodiment, the circuit protection unit 20A including a conductive member 30A including a flat plate portion 34 is adopted instead of the circuit protection unit 20 in the first embodiment. Hereinafter, the same members and the same parts as those in the first embodiment will be denoted by the same reference signs, and the description thereof will be omitted or simplified.

The conductive member 30A includes the flat plate portion 34 and is made of, for example, copper, a copper alloy, aluminum, or an aluminum alloy. Similarly to the conductive member 30 of the first embodiment, the conductive member 30A includes the flat plate portion 34, a fusible region S1 and a non-fusible region S2 provided in the flat plate portion 34, and further an electric wire connection portion 36 (a coating crimp portion 36a and a conductor crimp portion 36b) and is integrally formed by the same base material. The flat plate portion 34 formed in a flat plate shape is caused to serve as a conductor connection portion that is fixed to the connection conductor 10 by laser welding or the like.

Once an overcurrent flows through the conductive member 30A, the fusible region S1 plated with the plating material M having a low melting point generates more heat than the non-fusible region S2. Therefore, the fusible region S1 is fusion-cut. If the fusible region S1 is fusion-cut and a substantially circular through-hole, for example, is formed, both parts of the through-hole in the first direction X still remain in a connected state. However, since the sectional area of the parts on both sides of the through-hole in the first direction X is smaller than those of the other parts of the flat plate portion 34, the resistance at the parts on both sides increases, and the parts on both sides are fusion-cut. In other words, it is possible to plate the part located on the side further inward than the edge portion of the conductive member 30A with the plating material M so that the through-hole is formed by the fusion-cutting. It is thus possible to use only a necessary minimum amount of plating material M. In this manner, the circuit protection unit 20A fusion-cuts the fusible region S1 of the conductive member 30A when an overcurrent flows and disconnects energization between the connection conductor 10 and the battery monitoring unit 100.

### Third Embodiment

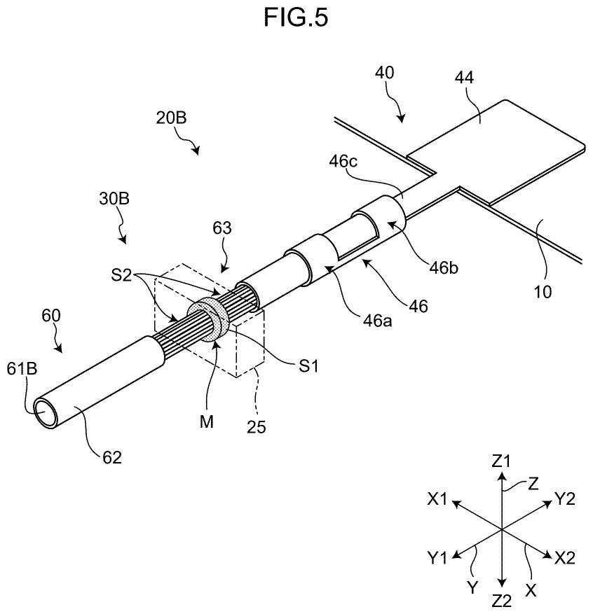

Next, a third embodiment will be described on the basis of FIG. 5. In regard to a circuit protection unit 20B of the present embodiment, the circuit protection unit 20B including a conductive member 30B made of an electric wire 60 is adopted instead of the circuit protection unit 20 of the first embodiment. Hereinafter, the same members and the same parts as those in the first embodiment will be denoted by the same reference signs, and the description thereof will be omitted or simplified.

A metal terminal 40 is provided at a terminal of the electric wire 60. The metal terminal 40 includes an electric wire connection portion 46 including a coating crimp portion 46a and a conductor crimp portion 46b, an intermediate portion 46c, and a conductor connection portion 44 with a flat plate shape. The electric wire connection portion 46 (the coating crimp portion 46a and the conductor crimp portion 46b) is configured similarly to the electric wire connection portion 36 (the coating crimp portion 36a and the conductor crimp portion 36b) of the conductive member 30 in the first embodiment. The electric wire connection portion 46 is connected to the conductor connection portion 44 via the intermediate portion 36c and is conducted therewith. The conductor connection portion 44 is fixed to the connection conductor 10 by laser welding or the like. An electric wire 60 is connected to the electric wire connection portion 46. Conduction is established among the connection conductor 10, the metal terminal 40, and the electric wire 60.

A core wire 61B of the electric wire 60 in the present embodiment is a twisted wire obtained by twisting a plurality of strands. The conductive member 30B in the present embodiment is caused to serve as a core wire exposed portion 63 where a coating portion 62 as a part of the electric wire 60 is peeled off and the core wire 61B is exposed, on one side Y1 in a second direction Y beyond the metal terminal 40. Here, the plurality of strands of the core wire 61 are made of copper, a copper alloy, aluminum, or an aluminum alloy. The conductive member 30B includes a fusible region S1 and a non-fusible region S2 provided in the core wire exposed portion 63 of the core wire 61B. The fusible region S1 is plated with a plating material M. The plating material M is annularly provided on the outer periphery of the core wire 61B. This can cause corrosion of the strands from the part around the core wire 61B due to heat generation in the fusible region S1 and cause the strands to be fusion-cut.

In addition, the circuit protection unit 20B can be provided with a cover 25 that covers the fusible region S1. The cover 25 leads to relatively higher thermal insulation in the fusible region S1 than thermal insulation in the non-fusible region S2, which is a part other than the fusible region S1, by covering the fusible region S1. In other words, since the inside and the outside of the cover 25 are substantially not ventilated, it is possible to obtain a higher temperature inside the cover 25 than outside the cover 25. Therefore, once an overcurrent flows through the core wire 61B, the temperature inside the cover 25 becomes higher than the temperature outside the cover 25 due to heat generation in the fusible region S1. Accordingly, fusion-cutting of the fusible region S1 is promoted by the cover 25. Note that the fusion-cutting of the fusible region S1 is further promoted by the cover 25 being formed by a heat insulating material. In addition, although the cover 25 is formed in a substantially rectangular parallelepiped box shape in the present embodiment, other forms can also be adopted.

### Fourth Embodiment

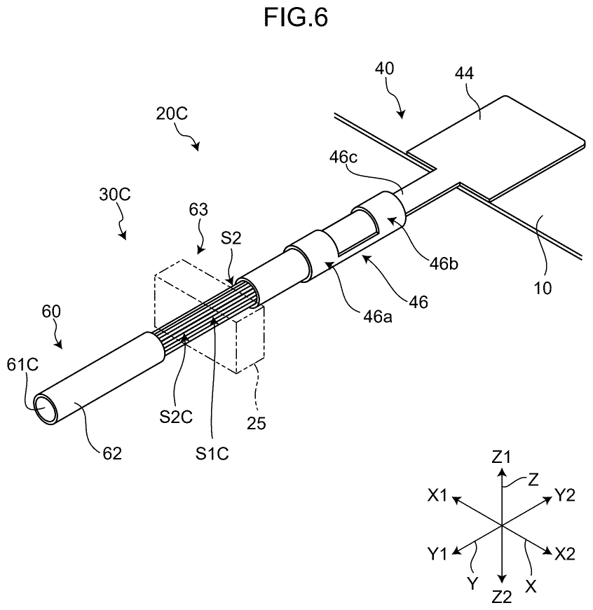

Next, a fourth embodiment will be described on the basis of FIG. 6. A circuit protection unit 20C of the present embodiment is obtained by adopting a fusible region S1C provided with a cover 25 instead of the fusible region S1 plated with the plating material M in the circuit protection unit 20B of the third embodiment. Hereinafter, the same members and the same parts as those in the first embodiment and the third embodiment will be denoted by the same reference signs, and the description thereof will be omitted or simplified.

A core wire 61C of an electric wire 60 in the present embodiment is a twisted wire obtained by twisting a plurality of strands. A conductive member 30C is caused to serve as a core wire exposed portion 63 where the core wire 61C is exposed at a metal terminal 40 on one side Y1 in a second direction Y. Conduction is established between the conductive member 30C and a connection conductor 10 via the metal terminal 40 and the electric wire 60 fixed to the metal terminal 40. The conductive member 30C establishes conduction between the connection conductor 10 and a battery monitoring unit 100.

A cover 25 is provided so as to surround and cover a part of the core wire 61C. A fusible region S1C is the core wire 61C inside the cover 25. A non-fusible region S2C is the core wire 61C at the core wire exposed portion 63 outside the cover 25. In other words, the non-fusible region S2C is not covered with the cover 25.

The conductive member 30C includes the fusible region S1C that is fusion-cut when an overcurrent flows between the connection conductor 10 and the battery monitoring unit 100 and the non-fusible region S2C that is adjacent to the fusible region S1C. In the conductive member 30C, the fusible region S1C and the non-fusible region S2C are integrally formed by the core wire 61C that is the same base material. Then, the cover 25 leads to relatively higher thermal insulation in the fusible region S1C than thermal insulation in the non-fusible region S2C. Therefore, the temperature in the fusible region S1C becomes higher than the temperature in the non-fusible region S2C, and fusion-cutting of the fusible region S1C is promoted when an overcurrent flows.

The circuit protection units 20, 20A, and 20B described above include the conductive members 30, 30A, and 30B that establish conduction between the connection conductor 10 that is the first electrical connection target and the battery monitoring unit 100 that is the second electrical connection target, the conductive members 30, 30A, and 30B include the fusible region S1 that is fusion-cut when an overcurrent flows between the connection conductor 10 and the battery monitoring unit 100 and the non-fusible region S2 that is adjacent to the fusible region S1, the fusible region S1 and the non-fusible region S2 are integrally formed of the same base material, the fusible region S1 is plated with the plating material M having a lower melting point than the base material, and the non-fusible region S2 is not plated with the plating material M. The conductive module 1 includes the connection conductor 10 and the circuit protection units 20, 20A, and 20B.

Thus, it is possible to form the fusible region S1 merely by plating the same base material for forming the metal plate material and the core wire 61B of the electric wire 60 with the plating material M. Here, in order to protect a circuit or the like to which the battery monitoring unit 100 is electrically connected, for example, a circuit protection unit using another component such as a chip fuse may be configured. In this case, the chip fuse or the like is assembled over each terminal on the side of the connection conductor 10 and the side of the battery monitoring unit 100 so that the connection conductor 10 and the battery monitoring unit 100 are electrically connected via the chip fuse or the like. Work such as assembling of the chip fuse or the like is complicated. However, if the fusible region S1 is formed merely by plating the same base material with the plating material M, then the complicated work is reduced, and it is thus possible to improve workability related to production of the circuit protection units 20, 20A, and 20B and the conductive module 1.

Also, the conductive member 30 includes the first conductive portion 31 on the side of the connection conductor 10, the second conductive portion 32 on the side of the battery monitoring unit 100, and the coupling portion 33 provided between the first conductive portion 31 and the second conductive portion 32, the coupling portion 33 is formed to have a sectional area that is smaller than the sectional area of the first conductive portion 31 and is smaller than the sectional area of the second conductive portion 32, and the fusible region S1 and the non-fusible region S2 are provided in the coupling portion 33. Accordingly, fusion-cutting can be promoted when an overcurrent further flows in the fusible region S1 in the coupling portion 33 having the smaller sectional area than the first conductive portion 31 and the second conductive portion 32.

In addition, the conductive member 30A includes the flat plate portion 34, the flat plate portion 34 is fixed to the connection conductor 10, and the fusible region S1 and the non-fusible region S2 are provided therein. Thus, even the flat plate portion 34 with a flat plate shape, which is a simple shape, can promote the fusion-cutting by the fusible region S1 when an overcurrent flows.

Also, the conductive member 30B is an electric wire 60 including the core wire 61B that is the twisted wire obtained by twisting the plurality of strands. As a result, it is possible to form the conductive member 30B by using the electric wire 60 including the core wire 61B that is the twisted wire and to form the circuit protection unit 20B.

Also, the plating material M is tin plating, and the base material is copper, a copper alloy, aluminum, or an aluminum alloy. As a result, the plating material M can be tin plating having a lower melting point than copper, a copper alloy, aluminum, or an aluminum alloy, and fusion-cutting of the fusible region S1 at the time of overcurrent is reliably promoted.

Also, the circuit protection units 20, 20A, and 20B include the cover 25 that covers the fusible region S1 and leads to relatively higher thermal insulation in the fusible region S1 than thermal insulation in the non-fusible region S2. It is thus possible to further promote the fusion-cutting of the fusible region S1.

Also, the conductive member 30C that establishes conduction between the connection conductor 10 that is the first electrical connection target and the battery monitoring unit 100 that is the second electrical connection target is included, the conductive member 30C includes the fusible region S1C that is fusion-cut when an overcurrent flows between the connection conductor 10 and the battery monitoring unit 100 and the non-fusible region S2C that is adjacent to the fusible region S1C, the fusible region S1C and the non-fusible region S2C are integrally formed of the same base material, and the fusible region S1C is covered with the cover 25 that leads to relatively higher thermal insulation in the fusible region S1C than thermal insulation in the non-fusible region S2C. In addition, the conductive module 1 can include the connection conductor 10 and the circuit protection unit 20C. As a result, it is possible to cause the conductive part inside the cover 25 with the simple configuration to serve as the fusible region S1C and to thereby improve workability related to production of the circuit protection unit 20C and the conductive module 1.

Note that the circuit protection units and the conductive module according to the above-described embodiments of the present invention are not limited to those in the above-described embodiments, and various modifications can be made within the scope as claimed in the claims.

Although the circuit protection units 20, 20A, 20B, and 20C have been assumed to be provided in the conductive module 1 in the above description, they can be provided to protect circuits in other devices. In addition, although the routing material W has been assumed to include the plurality of electric wires 60, it is also possible to adopt a flat routing material such as a flexible flat substrate, for example, as the routing material W. In this case, a wiring pattern of the flat routing material and the electric wire 60 in each of the circuit protection units 20, 20A, 20B, and 20C are electrically connected. Furthermore, although the circuit protection unit 20C in which the fusible region S1C is formed by the cover 25 instead of the plating material M adopts the electric wire 60 including the core wire 61C that is a twisted wire, the present invention is not limited thereto. For example, it is also possible to form the fusible region S1C by providing the cover 25 on the exposed portion exposed by peeling the coating portion 62 of the core wire 61C made of one single-core conductive wire.

The circuit protection unit and the conductive module according to the present embodiments may be configured by appropriately combining the components in the embodiments and the modifications described above.

The circuit protection unit and the conductive module according to the present embodiment have an effect that it is possible to improve workability related to production of the circuit protection unit and the conductive module.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A circuit protection unit comprising:
a conductive member that establishes conduction between a first electrical connection target and a second electrical connection target, wherein the conductive member includes a fusible region that is fusion-cut when an overcurrent flows between the first electrical connection target and the second electrical connection target and a non-fusible region that is adjacent to the fusible region, the fusible region and the non-fusible region being integrally formed by a same base material,
the fusible region is plated with a plating material having a lower melting point than the base material, and
the non-fusible region is not plated with the plating material.

2. The circuit protection unit according to claim 1, wherein
the conductive member includes a first conductive portion on a side of the first electrical connection target, a second conductive portion on a side of the second electrical connection target, and a coupling portion provided between the first conductive portion and the second conductive portion,
the coupling portion is formed to have a sectional area that is smaller than a sectional area of the first conductive portion and is smaller than a sectional area of the second conductive portion, and
the fusible region and the non-fusible region are provided in the coupling portion.

3. The circuit protection unit according to claim 1, wherein
the conductive member has a flat plate portion, and
the flat plate portion is fixed to the first electrical connection target, the fusible region and the non-fusible region being provided in the flat plate portion.

4. The circuit protection unit according to claim 1, wherein
the conductive member is an electric wire including, as a core wire, a twisted wire obtained by twisting a plurality of strands.

5. The circuit protection unit according to claim 1, wherein
the plating material is tin plating, and
the base material is copper, a copper alloy, aluminum, or an aluminum alloy.

6. The circuit protection unit according to claim 1, further comprising:
a cover that covers the fusible region that leads to relatively higher thermal insulation in the fusible region than thermal insulation in the non-fusible region.

7. The circuit protection unit according to claim 2, further comprising:
a cover that covers the fusible region that leads to relatively higher thermal insulation in the fusible region than thermal insulation in the non-fusible region.

8. The circuit protection unit according to claim 3, further comprising:
a cover that covers the fusible region that leads to relatively higher thermal insulation in the fusible region than thermal insulation in the non-fusible region.

9. The circuit protection unit according to claim 4, further comprising:
a cover that covers the fusible region that leads to relatively higher thermal insulation in the fusible region than thermal insulation in the non-fusible region.

10. A circuit protection unit comprising:
a conductive member that establishes conduction between a first electrical connection target and a second electrical connection target, wherein
the conductive member includes a fusible region that is fusion-cut when an overcurrent flows between the first electrical connection target and the second electrical connection target and a non-fusible region that is adjacent to the fusible region, the fusible region and the non-fusible region being integrally formed by a same base material, and
the fusible region is covered with a cover that leads to relatively higher thermal insulation in the fusible region than thermal insulation in the non-fusible region.

11. A conductive module comprising:
a connection conductor that is electrically connected to an electrode terminal of a battery cell constituting a battery module; and
a circuit protection unit that electrically connects a battery monitoring unit that monitors a battery state of the battery cell to the connection conductor, wherein
the circuit protection unit includes:
a conductive member that establishes conduction between the connection conductor and the battery monitoring unit,
the conductive member includes a fusible region that is fusion-cut when an overcurrent flows between the connection conductor and the battery monitoring unit and a non-fusible region that is adjacent to the fusible region, the fusible region and the non-fusible region being integrally formed by a same base material,
the fusible region is plated with a plating material having a lower melting point than the base material, and
the non-fusible region is not plated with the plating material.

12. A conductive module comprising:
a connection conductor that is electrically connected to an electrode terminal of a battery cell constituting a battery module; and
a circuit protection unit that electrically connects a battery monitoring unit that monitors a battery state of the battery cell to the connection conductor, wherein
the circuit protection unit includes:
a conductive member that establishes conduction between the connection conductor and the battery monitoring unit,
the conductive member includes a fusible region that is fusion-cut when an overcurrent flows between the connection conductor and the battery monitoring unit and a non-fusible region that is adjacent to the fusible region, the fusible region and the non-fusible region being integrally formed by a same base material, and
the fusible region is covered with a cover that leads to relatively higher thermal insulation in the fusible region than thermal insulation in the non-fusible region.
